(19) United States
(12) Patent Application Publication
(10) Pub. No.: US 2024/0295779 A1
(43) Pub. Date: Sep. 5, 2024

(54) INTERDIGITATED ELECTRODE ASSEMBLIES, LIQUID CRYSTAL DEVICES, AND METHODS FOR MANUFACTURE

(71) Applicant: CORNING INCORPORATED, CORNING, NY (US)

(72) Inventors: Douglas Llewellyn Butler, Painted Post, NY (US); Eric John Mozdy, Huntersville, NC (US); Dragan Pikula, Horseheads, NY (US)

(21) Appl. No.: 18/571,310

(22) PCT Filed: Jun. 3, 2022
(86) PCT No.: PCT/US2022/032145

§ 371 Date: Dec. 18, 2023

Related U.S. Application Data
(60) Provisional application No. 63/211,721, filed on Jun. 17, 2021.

(51) Int. Cl. G02F 1/1343

(52) U.S. Cl. CPC G02F 1/134363

(57) ABSTRACT

Disclosed are interdigitated electrode assemblies and liquid crystal devices and windows including such assemblies, wherein the interdigitated electrode assembly comprises: a substrate: a plurality of first electrodes and a plurality of second electrodes, wherein the plurality of first electrodes and the plurality of second electrodes are interdigitated: at least one first insulator which overlays at least a portion of the plurality of second electrodes: and a first bus bar which overlays the at least one first insulator and does not electrically contact the plurality of second electrodes. Also disclosed are methods for manufacturing interdigitated electrode assemblies and liquid crystal devices and windows including those assemblies.

### CROSS-REFERENCE TO RELATED APPLICATIONS

This application claims the benefit of priority under 35 U.S.C. § 119 of U.S. Provisional Application No. 63,211,721 filed Jun. 17, 2021, the content of which is incorporated herein by reference in its entirety.

### FIELD OF THE DISCLOSURE

The disclosure relates generally to liquid crystal devices and assemblies comprising at least one interdigitated electrode and methods for manufacturing such assemblies and devices. More particularly, the disclosure relates to liquid crystal devices utilizing in-plane switching and including at least one interdigitated electrode assembly and methods for manufacturing such devices.

### BACKGROUND

Liquid crystal devices are used in various architectural and transportation applications, such as windows, doors, space partitions, and skylights for buildings and automobiles. For many commercial applications, it is desirable for liquid crystal devices to provide high transmission in the bright state and high contrast ratio between the on and off states while also providing good energy efficiency and cost effectiveness. In the case of liquid crystal windows, it is desirable to decrease optical losses as much as possible in the bright state to maximize the amount of light that enters through the window. Additionally, to achieve a high contrast ratio, the window should attenuate as much of the incident light as possible in the dark state.

Liquid crystal devices utilizing interdigitated electrodes, such as an in-plane switching (IPS) electrode pattern, can provide an attractive low-cost design because they require electrode placement on only one of the two substrates making up the liquid crystal cell. For instance, outer substrates with interdigitated electrodes can generate a field that penetrates the liquid crystal layer without the need for an opposing electrode on the interstitial substrate. This design may reduce the driving voltage, improve energy efficiency, and also reduce the manufacturing cost associated with depositing electrode layers on both sides of the liquid crystal layer(s).

A remaining challenge for manufacturing liquid crystal devices utilizing IPS is how to connect the interdigitated electrodes to a driving circuit in a manner compatible with a low-cost, high-volume manufacturing process. IPS design requires layering electrode material to create an interdigitated or alternating pattern of positive and negative electrodes. These interdigitated electrodes are connected to common bus lines that connect the respective positive and negative electrodes to the driver circuitry. Traditional deposition of IPS electrodes requires the prior knowledge of the device geometry, such that the deposited interdigitated electrodes can be electrically tied together by a common bus bar at an edge of the substrate. As such, this approach is unsuitable for large scale processing for devices such as windows, where the final substrate or device is cut to order from a larger template or “motherboard” sheet. Specifically, because the sizes and locations of the cut-to-order substrate will vary, the electrode deposition process cannot be tailored to include the bus bars in the motherboard fabrication process. The template sheet must instead be populated with alternating electrodes that are interconnected after cutting the individual substrates. After the individual substrate is cut, the bus bars can be applied as appropriate. However, connecting each electrode to the appropriate bus bar after cutting the substrate can pose a number of challenges, which are addressed herein.

As such, there is a need for interdigitated electrode assemblies and liquid crystal devices that can be cut-to-order and manufactured using a large-scale process. It would also be advantageous to provide a cost-effective method for applying common bus bars to cut-to-order substrates comprising interdigitated electrodes.

### SUMMARY

The disclosure relates, in various embodiments, to interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; at least one first insulator positioned on the first major surface proximate the first edge of the substrate, wherein the at least one first insulator overlays at least a portion of the plurality of second electrodes; and a first bus bar positioned on the first major surface proximate the first edge of the substrate, wherein the first bus bar overlays the at least one first insulator and does not electrically contact the plurality of second electrodes.

According to certain embodiments, the interdigitated electrode assemblies can further comprise: at least one second insulator, wherein the at least one second insulator overlays at least a portion of the plurality of first electrodes; and a second bus bar, wherein the second bus bar overlays the at least one second insulator and does not electrically contact the plurality of first electrodes. In non-limiting embodiments, the at least one second insulator and the second bus bar are positioned on the first major surface proximate the second edge of the substrate. In alternative embodiments, the at least one second insulator and the second bus bar are positioned on the first major surface adjacent the at least one first insulator and the first bus bar.

The at least one insulator can, in some embodiments, comprise a discontinuous layer of insulating material extending in a second direction transverse to the first direction of the electrodes. The at least one first insulator does not contact the plurality of first electrodes in various embodiments. In additional embodiments, the at least one second insulator can comprise a discontinuous layer of insulating material extending in a second direction transverse to the first direction. The at least one second insulator does not contact the plurality of second electrodes in certain embodiments.

The at least one insulator can, in additional embodiments, comprises a continuous layer of insulating material overlaying both the plurality of first electrodes and the plurality of second electrodes. In further embodiments, the first bus bar can extend in a second direction transverse to the first direction and comprise a plurality of first protrusions extending through the at least one first insulator to electrically contact the plurality of first electrodes. According to various embodiments, a distance between the first protrusions on the first bus bar is substantially equal to a distance between first electrodes on the first major surface of the substrate. In further embodiments, a second bus bar can extend in a second direction transverse to the first direction and can comprise a plurality of second protrusions extending through the at least one first insulator to electrically contact the plurality of second electrodes. According to yet further embodiments, a distance between the second protrusions on the second bus bar is substantially equal to a distance between second electrodes on the first major surface of the substrate.

The disclosure also relates to interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a first bus bar positioned on the first major surface proximate the first edge of the substrate and extending in a second direction transverse to the first direction. The first bus bar can be patterned with a plurality of first protrusions spaced apart by a distance substantially equal to a distance between first electrodes. The first bus bar can electrically contact the plurality of first electrodes but does not electrically contact the plurality of second electrodes.

The interdigitated electrode assemblies can, in various embodiments, further comprise a second bus bar patterned with a plurality of second protrusions spaced apart by a distance substantially equal to a distance between the second electrodes. The second bus bar can electrically contact the plurality of second electrodes but does not electrically contact the plurality of first electrodes. According to certain embodiments, the second bus bar can be positioned on the first major surface proximate the second edge of the substrate. In alternative embodiments, the second bus bar can be positioned on the first major surface adjacent the first bus bar.

Further disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a bus bar positioned on the first major surface proximate the first edge of the substrate and extending in a second direction transverse to the first direction. The bus bar can comprise a first conductive region and a second conductive region separated by an insulating region and may be patterned with a plurality of first protrusions and a plurality of second protrusions. The first protrusions can be spaced apart by a first distance substantially equal to a distance between the first electrodes and can electrically contact the plurality of first electrodes. The second protrusions can be spaced apart by a second distance substantially equal to a distance between the second electrodes and can electrically contact the plurality of second electrodes. According to non-limiting embodiments, the first conductive region of the bus bar does not electrically contact the plurality of second electrodes and the second conductive region of the bus bar does not electrically contact the plurality of first electrodes.

Still further disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a first bus bar positioned on the first major surface proximate the first edge of the substrate and extending in a second direction transverse to the first direction. The first major surface of the substrate can comprise a surface texture that prevents physical and electrical contact between the first bus bar and the plurality of second electrodes. In additional embodiments, the interdigitated electrode assemblies can further comprise a second bus bar positioned on the first major surface proximate the second edge of the substrate. The surface texture of the first major surface of the substrate can prevent physical contact between the second bus bar and the first plurality of electrodes.

In some embodiments, the surface texture can comprise peaks and troughs. Along a first transverse plane proximate the first edge of the substrate, the plurality of second electrodes can be disposed in the troughs and the plurality of first electrodes can be disposed on the peaks. The first bus bar can be disposed along the first transverse plane proximate the first edge of the substrate according to various embodiments. Along a second transverse plane proximate the second edge of the substrate, the plurality of first electrodes can be disposed in the troughs and the plurality of second electrodes can be disposed on the peaks. The second bus bar can be disposed along the second transverse plane proximate the second edge of the substrate according to certain embodiments.

Still further disclosed herein are liquid crystal devices and liquid crystal windows comprising the interdigitated electrode assemblies disclosed herein. According to various embodiments, the liquid crystal devices and liquid crystal windows can comprise a first outer substrate, a second outer substrate, an interstitial substrate, a first liquid crystal layer disposed between the first outer substrate and the interstitial substrate, and a second liquid crystal layer disposed between the second outer substrate and the interstitial substrate. At least one of the first outer substrate, second outer substrate, and interstitial substrate can comprise the interdigitated electrode assembly.

Methods for making interdigitated electrode assemblies are also disclosed herein. The methods can comprise, for example, depositing a plurality of first electrodes and a plurality of second electrodes on a first major surface of a template sheet; singulating the template sheet to produce at least one patterned substrate comprising the plurality of first electrodes and the plurality of second electrodes extending on a first major surface of the patterned substrate along a first direction from a first edge to a second edge of the patterned substrate; and positioning a first bus bar on the first major surface proximate the first edge of the patterned substrate along a second direction transverse to the first direction. The plurality of first electrodes and the plurality of second electrodes can be interdigitated on the first major surface of the template sheet and patterned substrate. In some embodiments, the first bus bar can overlay the plurality of first electrodes and the plurality of second electrodes but does not electrically contact the plurality of second electrodes. According to various embodiments, the methods can further comprise positioning a second bus bar on the first major surface of the patterned substrate along the second direction. The second bus bar can overlay the plurality of first electrodes and the plurality of second electrodes but does not electrically contact the plurality of first electrodes.

The methods can, in various embodiments, further comprise positioning at least one first insulator on the first major surface proximate the first edge of the patterned substrate along the second direction and overlaying the at least one first insulator with the first bus bar. In some embodiments, positioning the at least one first insulator can comprise applying a discontinuous layer of insulating material along the second direction. The at least one first insulator does not electrically contact the plurality of first electrodes according to certain embodiments. In non-limiting embodiments, the methods can further comprise positioning at least one second insulator on the first major surface along the second direction and overlaying the second bus bar with the at least one second insulator. In further embodiments, positioning the at least one second insulator can comprise applying a discontinuous layer of insulating material along the second direction. The at least one second insulator does not electrically contact the plurality of second electrodes according to various embodiments.

In additional embodiments, positioning the at least one first insulator comprises applying a continuous layer of insulating material overlaying both the plurality of first electrodes and the plurality of second electrodes. In such embodiments, the first bus bar can comprise a plurality of first protrusions extending through the at least one first insulator to electrically contact the plurality of first electrodes. According to various embodiments, the methods can further comprise positioning a second bus bar on the first major surface of the patterned substrate along the second direction. The second bus bar can overlay the plurality of first electrodes and the plurality of second electrodes and can comprises a plurality of second protrusions extending through the at least one first insulator to electrically contact the plurality of second electrodes.

The methods disclosed herein can, in some embodiments, further comprise patterning the first bus bar with a plurality of first protrusions. The distance between the first protrusions can be substantially equal to a distance between the first electrodes on the first major surface of the patterned substrate. The methods can still further comprise patterning the second bus bar with a plurality of second protrusions. The distance between the second protrusions can be substantially equal to a distance between the second electrodes on the first major surface of the patterned substrate. In alternative embodiments, the methods disclosed herein can further comprise patterning the first bus bar with a plurality of first insulators. The distance between the first insulators can be substantially equal to a distance between the second electrodes on the first major surface of the patterned substrate. The methods can further comprise patterning the second bus bar with a plurality of second insulators. The distance between the second insulators can be substantially equal to a distance between the first electrodes on the first major surface of the patterned substrate.

In still further embodiments, the methods disclosed herein can additionally comprise positioning at least one first insulator on the first major surface of the template sheet along the second direction prior to singulation. The at least one first insulator can overlay at least a portion of the plurality of second electrodes and the first bus bar can overlay the at least one first insulator when applied to the first major surface of the patterned substrate after singulation. The methods can further comprise positioning at least one second insulator on the first major surface of the template sheet along the second direction prior to singulation. The at least one second insulator can overlay at least a portion of the plurality of first electrodes and a second bus bar can overlay the at least one second insulator on the first major surface of the patterned substrate after singulation.

According to non-limiting embodiments, the methods disclosed herein can also comprise texturing the first major surface of the template sheet prior to depositing the plurality of first electrodes and the plurality of second electrodes. Texturing the first major surface of the template sheet can comprise providing the surface with a plurality of peaks and troughs according to various embodiments. In certain embodiments, the methods further comprise selecting a first position of the first bus bar proximate the first edge of the patterned substrate. At the selected first position a first elevation of the plurality of first electrodes relative to the first major surface of the patterned substrate can be greater than a second elevation of the plurality of second electrodes. In some embodiments, the methods further comprise positioning a second bus bar on the first major surface along the second direction and selecting a second position of the second bus bar. At the selected second position the second elevation of the plurality of second electrodes can be greater than the first elevation of the plurality of first electrodes.

Further disclosed herein are methods for making interdigitated electrode assemblies, the methods comprising: depositing a plurality of first electrodes and a plurality of second electrodes on a first major surface of a template sheet, wherein the plurality of first electrodes and the plurality of second electrodes are interdigitated; singulating the template sheet to produce at least one patterned substrate comprising the plurality of first electrodes and the plurality of second electrodes extending on a first major surface of the patterned substrate along a first direction from a first edge to a second edge of the patterned substrate; and positioning a bus bar on the first major surface proximate the first edge of the patterned substrate along a second direction transverse to the first direction. According to various embodiments, the bus bar comprises a first conductive region and a second conductive region separated by an insulating region and the bus bar overlays the plurality of first electrodes and the plurality of second electrodes. In non-limiting embodiments, the first conductive region of the bus bar does not electrically contact the plurality of second electrodes and the second conductive region of the bus bar does not electrically contact the plurality of first electrodes. According to certain embodiments, the methods further comprise patterning a first major surface of the bus bar with a plurality of first patterned conductors and a plurality of second patterned conductors. The first patterned conductors can be spaced apart by a first distance substantially equal to a distance between the first electrodes and electrically contact the plurality of first electrodes. The second patterned conductors can be spaced apart by a second distance substantially equal to a distance between the second electrodes and electrically contact the plurality of second electrodes.

Methods for assembling liquid crystal devices and liquid crystal windows are also disclosed herein. Such methods can comprise including at least one interdigitated electrode assembly disclosed herein as one or more substrates in the devices or windows.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework for understanding the nature and character of the claims. The accompanying drawings are included to provide a further understanding of the disclosure and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 depicts a cross sectional view of a liquid crystal device comprising an interdigitated electrode assembly and a single liquid crystal layer;

FIG. 2A depicts a cross sectional view of a liquid crystal device comprising two liquid crystal layers separated by an interstitial substrate and interdigitated electrode assemblies on the outer substrates of the liquid crystal cells;

FIG. 2B depicts a cross sectional view of a liquid crystal device comprising two liquid crystal layers separated by an interstitial substrate and interdigitated electrode assemblies on the interstitial substrate;

FIG. 3 depicts a top view of interdigitated electrodes connected by two common bus bars;

FIG. 4 depicts a flow chart for manufacturing of individual interdigitated electrode assemblies;

FIG. 5 depicts a flow chart for large-scale manufacturing of interdigitated electrode assemblies;

FIGS. 6A-B depict top views of interdigitated electrode assemblies according to certain embodiments of the disclosure;

FIG. 7 depicts a textured surface model for a motherboard sheet according to other embodiments of the disclosure;

FIG. 8 depicts a side view of an interdigitated electrode assembly according to additional embodiments of the disclosure;

FIG. 9 depicts a side view of an interdigitated electrode assembly according to various embodiments of the disclosure;

FIGS. 10A-B depict top and bottom views of a bus bar according to further embodiments of the disclosure, respectively; and

FIG. 11 depicts a top view of a patterned motherboard sheet according to yet further embodiments of the disclosure.

### DETAILED DESCRIPTION

Disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; at least one first insulator positioned on the first major surface proximate the first edge of the substrate, wherein the at least one first insulator overlays at least a portion of the plurality of second electrodes; and a first bus bar positioned on the first major surface proximate the first edge of the substrate, wherein the first bus bar overlays the at least one first insulator and does not electrically contact the plurality of second electrodes.

Also disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a first bus bar positioned on the first major surface proximate the first edge of the substrate and extending in a second direction transverse to the first direction. The first bus bar can be patterned with a plurality of first protrusions spaced apart by a distance substantially equal to a distance between first electrodes. The first bus bar can electrically contact the plurality of first electrodes but does not electrically contact the plurality of second electrodes.

Additionally disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a bus bar positioned on the first major surface proximate the first edge of the substrate and extending in a second direction transverse to the first direction. The bus bar can comprise a first conductive region and a second conductive region separated by an insulating region and may be patterned with a plurality of first protrusions and a plurality of second protrusions. The first protrusions can be spaced apart by a first distance substantially equal to a distance between the first electrodes and can electrically contact the plurality of first electrodes. The second protrusions can be spaced apart by a second distance substantially equal to a distance between the second electrodes and can electrically contact the plurality of second electrodes. According to non-limiting embodiments, the first conductive region of the bus bar does not electrically contact the plurality of second electrodes and the second conductive region of the bus bar does not electrically contact the plurality of first electrodes.

Further disclosed herein are interdigitated electrode assemblies comprising: a substrate comprising a first major surface, an opposing second major surface, a first edge, and an opposing second edge; a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and a first bus bar positioned on the first major surface proximate the first edge of the substrate and extending in a second direction transverse to the first direction. The first major surface of the substrate can comprise a surface texture that prevents physical and electrical contact between the first bus bar and the plurality of second electrodes.

Still further disclosed herein are liquid crystal devices and liquid crystal windows comprising such interdigitated electrode assemblies. According to various embodiments, the liquid crystal devices and liquid crystal windows can comprise a first outer substrate, a second outer substrate, an interstitial substrate, a first liquid crystal layer disposed between the first outer substrate and the interstitial substrate, and a second liquid crystal layer disposed between the second outer substrate and the interstitial substrate. At least one of the first outer substrate, second outer substrate, and interstitial substrate can comprise the interdigitated electrode assembly.

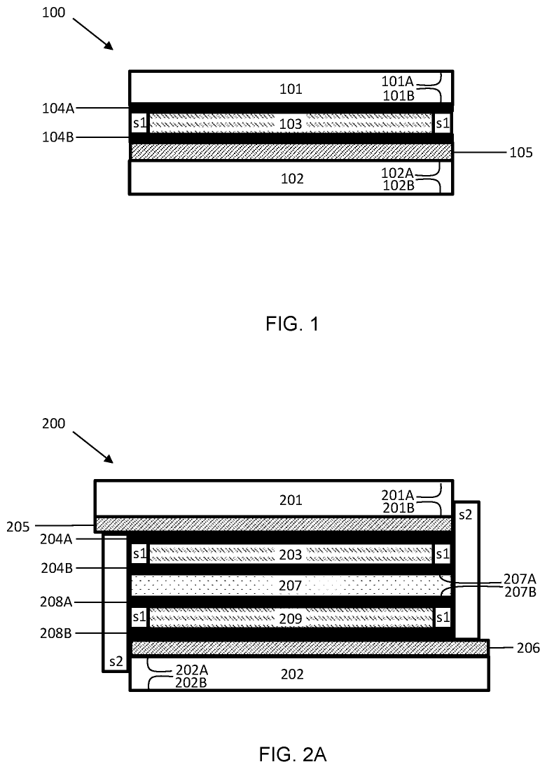

Embodiments of the disclosure will now be discussed with reference to FIGS. 1-11, which illustrate interdigitated electrode assemblies and liquid crystal devices according to various embodiments of the disclosure. The following general description is intended to provide an overview of the claimed devices, and various aspects will be more specifically discussed throughout the disclosure with reference to the non-limiting depicted embodiments, these embodiments being interchangeable with one another within the context of the disclosure.

### Liquid Crystal Devices

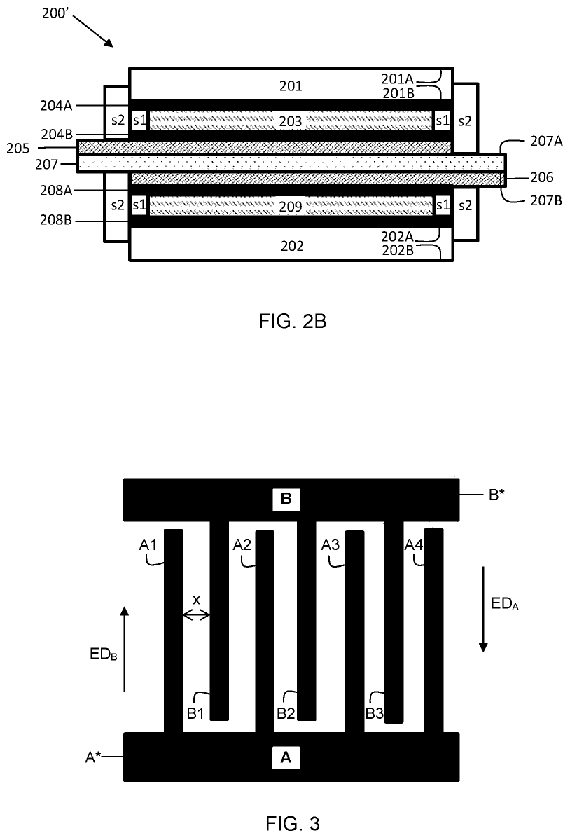

FIGS. 1 and 2A-B illustrate cross-sectional views of non-limiting embodiments of liquid crystal devices 100, 200, and 200′. The liquid crystal devices disclosed herein may comprise a single liquid crystal layer, as depicted in FIG. 1, or two liquid crystal layers, as depicted in FIGS. 2A-B, or more than two crystal liquid layers (not illustrated). Liquid crystal devices comprising two or more liquid crystal layers can, in some embodiments, comprise a single cell with interstitial glass (SWIG) configuration, as depicted in FIGS. 2A-B, although other configurations, such as a double cell structure, are also contemplated and are intended to be encompassed by the disclosure.

Referring to FIG. 1, liquid crystal device 100 includes first substrate 101 having a first (outer) surface 101A and a second (interior) surface 101B and second substrate 102 having a first (interior) surface 102A and second (outer) surface 102B. First and second substrates 101, 102 define a first cell gap that can be filled with liquid crystal material and sealed, e.g., via seals s1, to form first liquid crystal layer 103. Alignment layers 104A-B may be present on opposing sides of the first liquid crystal layer 103, or one or both of the alignment layers may not be present depending on the device design. Interdigitated electrode 105 is formed on and/or in direct contact with one of the interior surfaces of the substrates confining the first liquid crystal layer 103, i.e., second surface 101B of first substrate 101 (not illustrated) or first surface 102A of second substrate 102 (as illustrated in FIG. 1). In the depicted embodiment, an applied electric field directed from a higher voltage interdigitated electrode on first surface 102A can loop through first liquid crystal layer 103 and terminate at a lower voltage interdigitated electrode on surface 102A. In response to the applied electric field, the liquid crystal molecules in the liquid crystal layer can change their orientation, which will correspondingly impact the optical characteristics of the liquid crystal window, e.g., increasing or decreasing tint level. The orientation of liquid crystal material can be described by a unit vector, referred to herein as a “director,” which represents the average local orientation of the long molecular axes of the liquid crystal molecules.

Liquid crystal device 100 can be produced, in some embodiments, using the following exemplary process. If desired, an alignment layer 104A can be coated, printed, or otherwise deposited on the second surface 101B of the first substrate 101. Interdigitated electrode 105 can be coated, printed, or otherwise deposited on the first surface 102A of the second substrate 102, followed by patterning. A patterned interdigitated electrode can be manufactured using a process such as wet photolithography or dry photolithography and a shadow mask. If desired, an alignment layer 104B can be coated, printed, or otherwise deposited on the interdigitated electrode 105. The substrates 101, 102 can be arranged to form a gap, which can be filled with liquid crystal material to form liquid crystal layer 103. In some embodiments, spacers (not illustrated) can be used to maintain the desired cell gap and resulting liquid crystal layer thickness. The liquid crystal material can be sealed in the cell gap around all edges using any suitable material, such as optically or thermally curable resins, to form first seal s1.

A double cell structure, e.g., two side-by-side liquid crystal cell units, can also be used according to various embodiments. However, such double cell structures may have various drawbacks, such as increased overall weight and thickness of the unit and higher manufacturing cost and complexity due to the presence of additional glass layers and electrode components. The additional glass interfaces may also result in optical losses across the double cell structure. A single cell design with interstitial glass (SWIG) can be a cost saving alternative to double cell structures. The SWIG design allows for the removal of at least one glass sheet as compared to the conventional double cell design. The SWIG design can utilize a single interstitial glass substrate to separate two liquid crystal layers. However, certain SWIG designs may require the interstitial glass to act as an electrode and/or anchor layer for both liquid crystal layers. As such, the interstitial glass may comprise electrodes on both sides of the substrate, which correspond to the opposing electrodes on the outer substrates forming the liquid crystal cell. Alternatively, electrodes placed on the outermost two substrates could be used to drive the entire cell stack, but such a configuration may not be energy efficient since the field must pass through all layers of the cell including the interstitial substrate, resulting in a substantial increase in driving voltage. Utilizing interdigitated electrodes in a SWIG design may eliminate or otherwise remedy these drawbacks.

Referring to FIGS. 2A-B, liquid crystal devices 200, 200′ with a SWIG configuration include first substrate 201 having a first (outer) surface 201A and a second (interior) surface 201B; second substrate 202 having a first (interior) surface 202A and a second (outer) surface 202B; and third (interstitial) substrate 207 having a first (interior) surface 207A and a second (interior) surface 207B. First and third substrates 201, 207 define a first cell gap that can be filled with liquid crystal material and sealed, e.g., via seals s1, to form first liquid crystal layer 203. Second and third substrates 202, 207 define a second cell gap that can be filled with liquid crystal material and sealed, e.g., via seals s1, to form second liquid crystal layer 209. Alignment layers 204A-B and may be present on opposing sides of the first liquid crystal layer 203 and alignment layers 208A-B may be present on opposing sides of the second liquid crystal layer 209, or one or more of these alignment layers may not be present depending on the device design.

First interdigitated electrode 205 is formed on and/or in direct contact with one of the interior surfaces of the substrates confining the first liquid crystal layer 203, i.e., second surface 201B of first substrate 201 as depicted in FIG. 2A. The first interdigitated electrode 205 may also be formed on the first surface 207A of third substrate 207 as depicted in FIG. 2B. Similarly, second interdigitated electrode 206 is formed on and/or in direct contact with one of the interior surfaces of the substrates confining the second liquid crystal layer 209, i.e., first surface 202A of second substrate 202 as depicted in FIG. 2A. The second interdigitated electrode 206 may also be formed on the second surface 207B of third substrate 207 as depicted in FIG. 2B. Other combinations of electrode positions on any of surfaces 201B, 202A, 207A, and/or 207B are also possible and intended to fall within the scope of this disclosure.

Liquid crystal device 200 can be produced, in some embodiments, using the following exemplary process. First interdigitated electrode 205 can be deposited and patterned on the second surface 201B of the first substrate 201. Similarly, second interdigitated electrode 206 can be deposited and patterned on the first surface 202A of the second substrate 202. If desired, alignment layers 204B and/or 208A can be coated, printed, or otherwise deposited on the first surface 207A and second surface 207B of third substrate 207, respectively. If desired, alignment layers 204A and/or 208B can be coated, printed, or otherwise deposited on the first and second interdigitated electrodes 205, 206, respectively.

The substrates 201, 202, 207 can be arranged, with the third substrate 207 between the first and second substrates 201, 202 to form two gaps, which can be filled with liquid crystal material to form liquid crystal layers 203, 209. In some embodiments, spacers (not illustrated) can be used to maintain the desired cell gap and resulting liquid crystal layer thickness. The liquid crystal material can be sealed in the cell gaps around all edges using any suitable material, such as optically or thermally curable resins, to form first seal s1. A second seal s2 can optionally be applied to protect the exposed edges of the substrates and/or electrodes and/or any electrical connections within the device from mechanical impacts and exposure to liquids such as water or condensation.

Liquid crystal device 200′ can be produced, in some embodiments, using the following exemplary process. If desired, an alignment layer 204A can be coated, printed, or otherwise deposited on the second surface 201B of the first substrate 201. Similarly, if desired, an alignment layer 208B can be coated, printed, or otherwise deposited on first surface 202A of second substrate 202. First and second interdigitated electrodes 205, 206 can be deposited and patterned on opposing surfaces 207A, 207B of the third substrate 207, respectively. If desired, alignment layers 204B and/or 208A can be coated, printed, or otherwise deposited on the first and second interdigitated electrodes 205, 206, respectively.

The substrates 201, 202, 207 can be arranged, with the third substrate 207 between the first and second substrates 201, 202 to form two gaps, which can be filled with liquid crystal material to form liquid crystal layers 203, 209. In some embodiments, spacers (not illustrated) can be used to maintain the desired cell gap and resulting liquid crystal layer thickness. The liquid crystal material can be sealed in the cell gaps around all edges using any suitable material, such as optically or thermally curable resins, to form first seal s1. A second seal s2 can optionally be applied to protect the exposed edges of the substrates and/or electrodes and/or any electrical connections within the device from mechanical impacts and exposure to liquids such as water or condensation.

It is to be understood that the scope of the disclosure is not limited solely to the liquid crystal devices depicted in FIGS. 1 and 2A-B. The liquid crystal devices disclosed herein can comprise additional liquid crystal layers, substrates, alignment layers, electrode assemblies, and/or electrode layers, arranged in various different configurations. The liquid crystal devices disclosed herein can be used in various architectural and transportation applications. For example, the liquid crystal devices can be used as liquid crystal windows that can be included in doors, space partitions, skylights, and windows for buildings, automobiles, and other transportation vehicles such as trains, planes, boats, mobile homes, recreational vehicles, and the like.

A liquid crystal window may, in some embodiments, comprise an additional glass substrate, which is separated from the liquid crystal device by a gap. The additional glass substrate can comprise any suitable glass material having any desired thickness, including those discussed herein with respect to the first, second, and third substrates. The gap can be sealed and filled with air, an inert gas, or a mixture thereof, which may improve the thermal performance of the liquid crystal window. Suitable inert glasses include, but are not limited to, argon, krypton, xenon, and combinations thereof. Mixtures of inert gases or mixtures of one or more inert gases with air can also be used. Exemplary non-limiting inert gas mixtures include 90/10 or 95/5 argon/air, 95/5 krypton/air, or 22/66/12 argon/krypton/air mixtures. Other ratios of inert gases or inert gases and air can also be used depending on the desired thermal performance and/or end use of the liquid crystal window.

In various embodiments, the additional glass substrate is an interior pane, e.g., facing the interior of the building or vehicle, although the opposite orientation, with glass facing the exterior, is also possible, or both. Liquid crystal window devices for use in architectural applications can have any desired dimension including, but not limited to 2′×4′ (width×height), 3′×5′, 5′×8′, 6′×8′, 7×10′, 7′×12′. Larger and smaller liquid crystal windows are also envisioned and are intended to fall within the scope of this disclosure. Although not illustrated, it is to be understood that the liquid crystal device can comprise one or more additional components such as a frame or other structural component, a power source, and/or a control device or system.

### Interdigitated Electrode Assemblies

The liquid crystal devices disclosed herein may utilize IPS and can comprise at least one interdigitated electrode assembly. Interdigitated electrodes comprise two coplanar electrodes patterned on the same surface of a substrate, e.g., a substrate defining or confining a liquid crystal layer. Liquid crystal layer(s) can be controlled by interdigitated electrodes, in which an electric field starts at a higher voltage interdigitated electrode, travels through any surrounding media (such as an adjacent liquid crystal layer), and terminates at a lower voltage interdigitated electrode. A typical interdigitated electrode design comprising two coplanar electrodes is shown in FIG. 3. Electrode assemblies A and B comprise electrode segments A1, A2, A3, A4 and B1, B2, and B3, respectively, that extend toward each other in directions EDA, EDB, respectively, to form an interlocking pattern. Electrode assemblies A and B and their respective segments are proximate to one another but do not touch. Each A segment can be spaced apart from the adjacent B segment by a gap x, which can vary depending on cell design. Common bus bars A* and B* connect electrode segments A1, A2, A3, and A4 and B1, B2, and B3, respectively, to driving circuits.

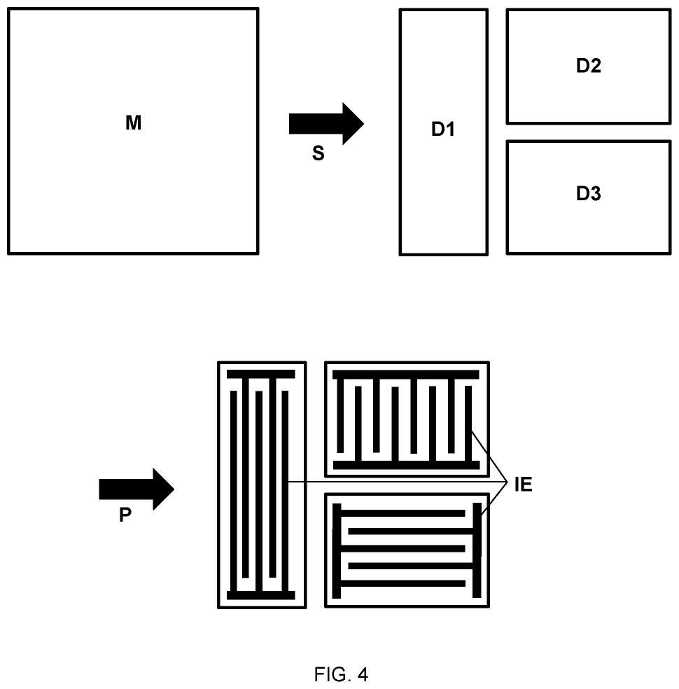

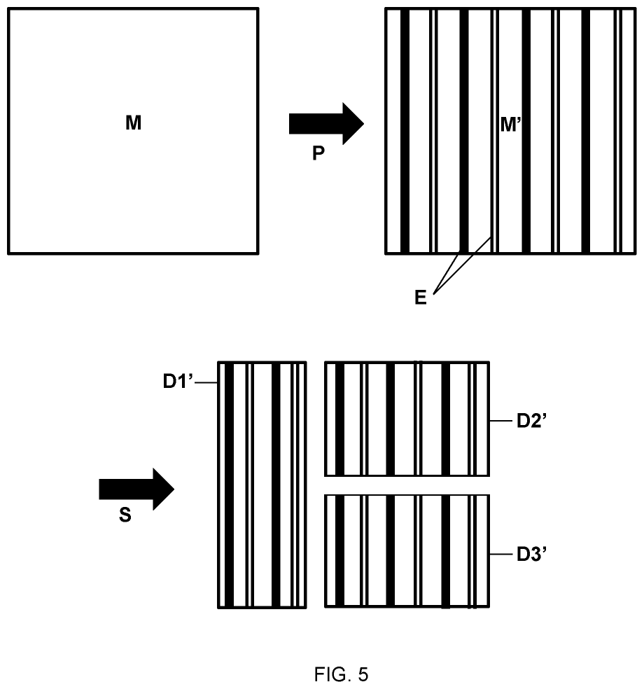

In a conventional fabrication process for interdigitated electrodes, the geometry and dimensions of the device or substrate are predetermined, e.g., a substrate is pre-cut to a specific shape and size before the interdigitated electrodes are applied. Referring to FIG. 4, a template or motherboard sheet M can be cut into predetermined shapes via a singulation step S to produce pre-cut substrates D1, D2, and D3. In processing step P, interdigitated electrodes IE can be deposited on one or more surfaces of the pre-cut substrates. One or more edges of the substrate can be chosen as the location for the common bus bars. The electrodes and bus bars can be deposited in step P such that the bus bar for one electrode set is not in electrical contact with the electrodes from the other set. For instance, the bus bar connecting the negative electrodes does not come into contact with the positive electrodes, and the bus bar connecting the positive electrodes likewise does not come into contact with the negative electrodes. As such, the deposited interdigitated electrodes IE include both the bus bars and the electrodes.

The design and orientation of interdigitated electrodes is relatively easy when the geometry of the substrate is predetermined. However, complications can arise in the case of larger-scale manufacturing using a template or “motherboard” sheet, as illustrated in FIG. 5. In such a large-scale fabrication process, the electrodes E are deposited onto the motherboard sheet M in processing step P to produce a patterned motherboard M′. It should be noted that electrodes E are depicted in an alternating pattern solely to represent a potential patterning of positive and negative electrodes. The size, orientation, and location of the electrodes E can vary across the patterned motherboard sheet M′ can vary. Additionally, the electrodes E can all comprise the same material or different materials, as desired by the user. The patterned motherboard M′ is then cut into desired shapes in singulation step S to produce patterned substrates D1′, D2′, and D3′. When electrodes E are deposited on the motherboard M, the geometry of the final device or substrate is unknown. Thus, it is not possible to predict locations for the bus bars that will eventually be needed to connect the electrodes E to the driving circuitry. After singulation in step S, the patterned substrates D1′, D2′, and D3′ must be further processed to add the bus bars and complete the interdigitated electrode assembly. However, since the electrodes E are generically applied and extend from edge to edge across the substrates, it can be difficult to apply a bus bar that contacts only one set of electrodes (e.g., negative electrodes) without contacting the other set of electrodes (e.g., positive electrodes).

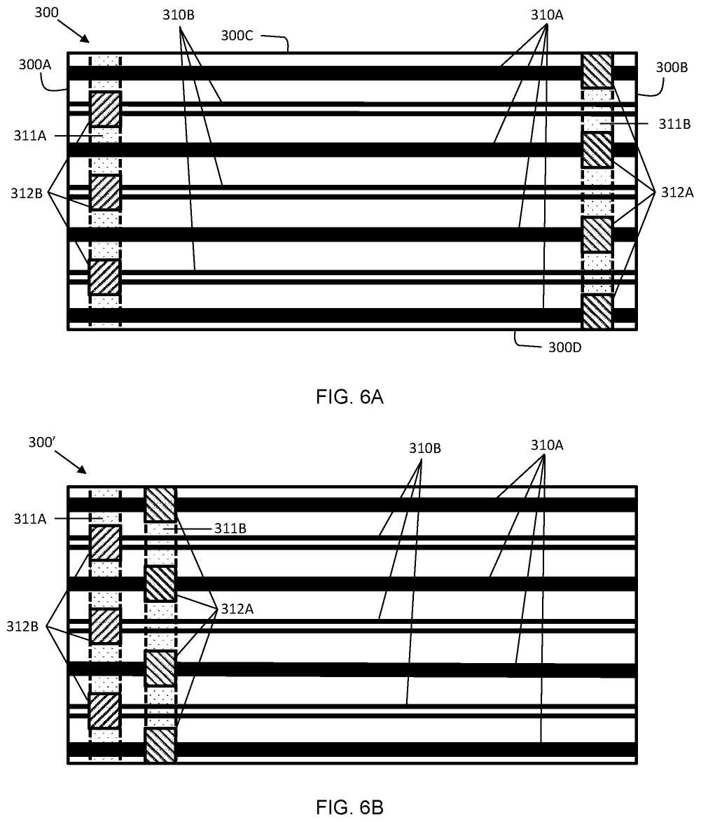

Methods for applying bus bars to substrates manufactured using a large-scale motherboard fabrication process will now be discussed with reference to FIGS. 6-11. The methods disclosed herein can, for example, be applied to the patterned substrates D1′, D2′, and D3′ illustrated in FIG. 5. As shown in FIGS. 6A-B, substrates 300, 300′ are patterned with alternating lines of electrodes 310A, 310B. As discussed above, these substrates can be cut from a generic template or motherboard sheet (not shown) to provide specific cut-to-order substrates having a desired geometry and/or size. After singulation, bus bars can be applied to connect each set of electrodes to their respective driving circuits. For example, first electrodes 310A, also interchangeably referred to herein as “A” electrodes, may be positive electrodes. Similarly, second electrodes 310B, also interchangeably referred to herein as “B” electrodes, may be negative electrodes. Of course, the disclosure is not limited to the depicted embodiment, i.e., first electrodes may be negative electrodes and second electrodes may be positive electrodes.

First and second electrodes 310A, 310B are deposited in an alternating (interdigitated) pattern, e.g., A-B-A-B-A-B, and extend from the first edge 300A to the second edge 300B of substrate 300. While electrodes 310A, 310B are depicted as fully extending from first edge 300A to second edge 300B, it is to be understood that the electrodes can extend along this direction but not necessarily touch the edges, depending on how the motherboard sheet is patterned and cut. First and second bus bars 311A, 311B are applied in a direction transverse to the electrodes 310A, 310B, e.g., extending from third edge 300C to fourth edge 300D. While bus bars 311A, 311B and electrodes 310A, 310B, are depicted as perpendicular to one another, it is to be understood that other angles of intersection are possible and are intended to fall within the scope of this disclosure. Moreover, while substrate 300 is depicted as having a rectangular shape, it is to be understood that other shapes are also possible, including shapes having curvilinear edges, and these substrates are also intended to fall within the scope of this disclosure.

A first bus bar 311A, also referred to herein as an “A” bus bar, or a positive bus bar, can be used to connect first electrodes 310A together and to a first driving circuit (not shown). Likewise, a second bus bar 311B, also referred to herein as a “B” bus bar, or a negative bus bar, can be used to connect second electrodes 310B together and to a second driving circuit (not shown). For illustrative purposes, bus bars 311A, 311B are depicted as transparent so the elements beneath the bus bar are visible. If applied to the substrate without modification, each bus bar would contact both the first and the second electrodes 310A, 310B, thus shorting the positive and negative electrodes together and making it impossible to distinctly connect each set of electrodes to its own driving circuit. As such, a modification is needed to ensure that first bus bar 311A electrically contacts only first electrodes 310A and second bus bar 311B electrically contacts only second electrodes 310B.

### Methods

The methods disclosed herein can, in certain embodiments, comprise modifications that allow for application of bus bars to substrates after singulation from a template sheet. The methods can comprise, for example, depositing a plurality of first electrodes and a plurality of second electrodes on a first major surface of a template sheet; singulating the template sheet to produce at least one patterned substrate comprising the plurality of first electrodes and the plurality of second electrodes extending on a first major surface of the patterned substrate along a first direction from a first edge to a second edge of the patterned substrate; and positioning a first bus bar on the first major surface proximate the first edge of the patterned substrate along a second direction transverse to the first direction. The plurality of first electrodes and the plurality of second electrodes can be interdigitated on the first major surface of the template sheet and patterned substrate. In some embodiments, the first bus bar can overlay the plurality of first electrodes and the plurality of second electrodes but does not electrically contact the plurality of second electrodes. According to various embodiments, the methods can further comprise positioning a second bus bar on the first major surface of the patterned substrate along the second direction. The second bus bar can overlay the plurality of first electrodes and the plurality of second electrodes but does not electrically contact the plurality of first electrodes. It is to be understood that the methods disclosed herein are not limited to the listed order of steps and the steps can be performed in different orders. For example, the first and/or second bus bars may be positioned on the substrate prior to singulation and so forth.

FIGS. 6A-B depict one potential modification, in which an insulating material is disposed between the bus bars and every other electrode. For example, in the case of a positive bus bar, such as first bus bar 311A, first insulators 312A can be used to block electrical contact with second (negative) electrodes 310B, so that first bus bar 311A is in electrical contact with only the first (positive) electrodes 310A. Similarly, for second bus bar 311B, second insulators 312B can be used to block electrical contact with first (positive) electrodes 310A, so that second bus bar 311B is in electrical contact with only second (negative) electrodes 310B. Generally speaking, bus bars may be placed near the edge(s) of the substrate so the driver circuitry can be easily attached during device fabrication and/or concealed by a device frame or casing. As shown in FIG. 6A, bus bars 311A, 311B can be disposed on opposing first and second edges 300A, 300B of the substrate 300. In other embodiments, as shown in FIG. 6B, bus bars 311A, 311B can be disposed along the same edge of substrate 300′. Such a configuration may have the advantages of freeing up space on the opposite side of the substrate for other functions, reducing complexity of the device frame, and/or providing more robust handling of the device. In some embodiments, it may be advantageous to position a pair of bus bars along one edge and a pair of bus bars along another edge of the substrate, e.g., to tailor the voltage transition, capacitance, inductance, or resistance of the liquid crystal cell. Of course, other bus bar locations, such as locations that are not adjacent to the substrate edges, are possible and intended to fall within the scope of the disclosure.

The insulating material can be directly deposited e.g., by ink-jet printing, chemical vapor deposition, or plasma sputtering techniques, onto the substrate 300, 300′ to prevent contact with alternating electrodes. The insulating material can, in some embodiments, be deposited as a discontinuous layer that overlays only alternate electrodes, e.g., only positive electrodes or only negative electrodes. For example, an insulator can comprise a discontinuous strip of first insulators 312A or second insulators 312B. The common bus bars can then be applied such that they overlay the appropriate insulator, thereby linking alternating electrodes together and to the appropriate driving circuitry. The insulating material can prevent electrical contact between the overlapping bus bar and the undesired electrodes and thus prevent a short between the negative and positive electrodes. Alternatively, insulating material can be applied directly to the bus bar in a spacing appropriate to prevent contact with alternating electrodes on the substrate. For example, insulating material can be discontinuously printed onto a conductive material, such as a metallic tape, and the patterned bus bar can then be applied directly to the substrate. Either of these methods can be carried out after singulation step S as depicted in FIG. 5.

According to various embodiments, the methods disclosed herein can comprise positioning at least one first insulator on the first major surface proximate the first edge of the patterned substrate along a second direction and overlaying the at least one first insulator with the first bus bar. In some embodiments, positioning the at least one first insulator can comprise applying a discontinuous layer of insulating material along the second direction. The at least one first insulator does not contact the plurality of first electrodes according to certain embodiments. In non-limiting embodiments, the methods can further comprise positioning at least one second insulator on the first major surface along the second direction and overlaying the second bus bar with the at least one second insulator. In further embodiments, positioning the at least one second insulator can comprise applying a discontinuous layer of insulating material along the second direction. The at least one second insulator does not contact the plurality of second electrodes according to various embodiments.

In alternative embodiments, the methods disclosed herein can comprise patterning the first bus bar with a plurality of first insulators. The distance between the first insulators can be substantially equal to a distance between the second electrodes on the first major surface of the patterned substrate. The methods can comprise patterning the second bus bar with a plurality of second insulators. The distance between the second insulators can be substantially equal to a distance between the first electrodes on the first major surface of the patterned substrate.

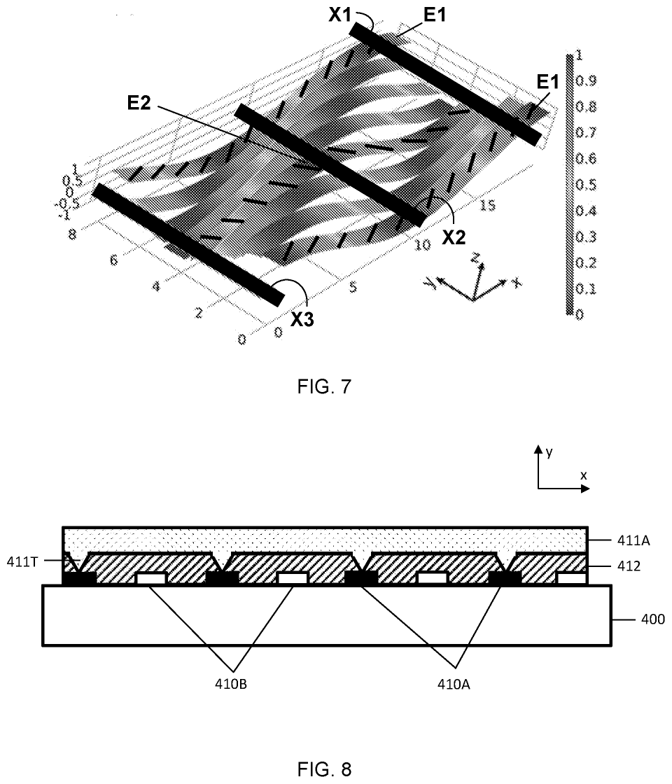

Referring now to FIG. 7, another exemplary method can include texturing or otherwise altering the surface of the template or motherboard sheet prior to depositing the first and second electrodes. Such a method can be carried out prior to processing step P as depicted in FIG. 5. FIG. 7 depicts a model of surface texture that can be used to modify the surface texture of the motherboard sheet prior to electrode deposition. The provided surface texture can cause one set of electrodes to protrude higher from the surface, e.g., have a higher elevation, than the neighboring alternate electrodes. As such, a bus bar applied to one location on the sheet would contact only one set of electrodes, i.e., the electrodes that protrude higher from the surface at that location. At another location, e.g., at the opposing edge of the substrate, the surface texture can cause the other set of electrodes to protrude higher from the surface, thereby enabling the electrically opposite contact. For example, as shown in FIG. 7, a positive bus bar (not illustrated) positioned along transverse planes X1, X3 would contact only positive electrodes (not illustrated) deposited in locations E1, which are the highest points or peaks on the surface at transverse planes X1, X3. The negative electrodes can be positioned at the lowest points or troughs of the surface texture such that they do not contact the positive bus bar. Similarly, a negative bus bar (not illustrated) positioned along transverse plane X2 would contact only negative electrodes (not illustrated) deposited in locations E2, which are the highest points or peaks on the surface at plane X2. The positive electrodes can be positioned at the lowest points or troughs of the surface texture such that they do not contact the negative bus bar. Alternating electrodes can thus be deposited depending on the pitch of the surface texture and the location and angle of the bus bars can be determined based on the desired electrode contact points. The angle of the electrodes with respect to the peaks and troughs and, thus, the angle of transverse planes X1, X2, and/or X3, can range from +90° to −90°, such as +60°, −60°, +30°, −30°, +45°, and −45°, including all ranges and subranges therebetween. Of course, the depicted texture is exemplary only and other surface textures are also envisioned and intended to fall within the scope of the disclosure.

According to non-limiting embodiments, the methods disclosed herein can comprise texturing the first major surface of a template sheet prior to depositing the plurality of first electrodes and the plurality of second electrodes. Texturing the first major surface of the template sheet can comprise providing the surface with a plurality of peaks and troughs according to various embodiments. Texturing can be carried out using any method suitable for altering the surface texture of a glass substrate, e.g., mechanical methods such as molding or sandblasting or chemical methods such as etching or lithography, to name a few. The distance between peaks and troughs can vary depending on the desired application. In certain embodiments, an average distance between peaks can range from about 1 μm to about 100 μm, such as from about 3 μm to about 0 μm, from about 5 μm to about 50 μm, from about 10 μm to about 40 μm, or from about 20 μm to about 30 μm, including all ranges and subranges therebetween. The average distance between peaks and troughs can also be less than 1 μm in some embodiments, or greater than 100 μm in other non-limiting embodiments.

For example, the electrode segments can have a width ranging from about 1 μm to about 20 μm and the gaps between adjacent electrode segments can have a width ranging from about 3 μm to about 100 μm.

In certain embodiments, the methods also comprise selecting a first position of the first bus bar proximate the first edge of the patterned substrate. At the selected first position a first elevation of the plurality of first electrodes from the surface of the patterned substrate can be greater than a second elevation of the plurality of second electrodes. In some embodiments, the methods further comprise positioning a second bus bar on the first major surface along the second direction and selecting a second position of the second bus bar. At the selected second position the second elevation of the plurality of second electrodes can be greater than the first elevation of the plurality of first electrodes.

FIG. 8 illustrates yet another exemplary modification, in which a substrate 400 is patterned with first electrodes 410A and second electrodes 410B, and a continuous insulating layer 412 is applied uniformly across both first and second electrodes 410A, 410B. The electrodes 410A, 410B can be applied along a first direction y, e.g., extending from a first edge (not illustrated) to a second edge (not illustrated) of the substrate 400. A continuous strip of insulating material can be applied along a second direction x that is transverse to direction y, e.g., extending from a third edge (not illustrated) to a fourth edge (not illustrated) of the substrate 400. The continuous insulator 412 can, for instance, be applied proximate to one or more edges of the substrate 400, such as the first or second edge (not illustrated). The continuous insulator 412 overlays at least a portion of both the first and second electrodes 410A, 410B. First bus bar 411A can be applied on top of the insulating layer 412 such that it overlays the continuous insulating layer 412 and may comprise protrusions or teeth 411T capable of penetrating the continuous insulating layer 412 and contacting the desired electrodes. In some embodiments, the spacing between the teeth 411T can correspond to the distance between alternating electrodes. As shown in FIG. 8, the teeth 411T of first bus bar 411A are spaced to correspond to the distance between first electrodes 410A. The teeth 411T penetrate through the insulating layer 412 to electrically contact first electrodes 410A, but do not come into electrical contact with second electrodes 410B. While not shown, a similar second bus bar with protrusions can be used to penetrate the continuous insulating layer 412 and contact the second electrodes 410B but not first electrodes 410A. The first and second bus bars can be on the same side of the substrate (e.g., similar to FIG. 6B) or on opposing sides of the substrate (e.g., similar to FIG. 6A). This method can be carried out after singulation step S as depicted in FIG. 5.

According to various embodiments, the methods disclosed herein can comprise positioning at least one first insulator on the first major surface proximate the first edge of the patterned substrate along the second direction and overlaying the at least one first insulator with the first bus bar. In additional embodiments, positioning the at least one first insulator comprises applying a continuous layer of insulating material overlaying both the plurality of first electrodes and the plurality of second electrodes. In such embodiments, the first bus bar can comprise a plurality of first protrusions extending through the at least one first insulator to electrically contact the plurality of first electrodes. According to various embodiments, the methods can further comprise positioning a second bus bar on the first major surface of the patterned substrate along the second direction. The second bus bar can overlay the plurality of first electrodes and the plurality of second electrodes and can comprises a plurality of second protrusions extending through the at least one first insulator to electrically contact the plurality of second electrodes.

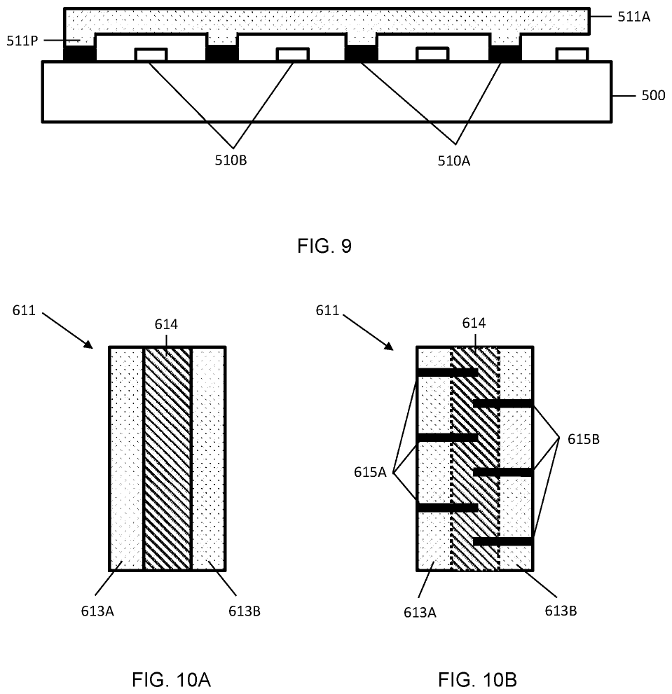

An alternative embodiment is depicted in FIG. 9, which is a side view of a substrate 500 patterned with first electrodes 510A and second electrodes 510B. A first bus bar 511A is applied to the substrate 500. First bus bar 511A is patterned, e.g., with protrusions 511P, which can contact the desired electrodes. In some embodiments, the spacing between protrusions 511P can correspond to the distance between alternating electrodes. As shown in FIG. 9, the protrusions 511P of first bus bar 511A are spaced to correspond to the distance between first electrodes 510A. The protrusions 511P comprise a conductive material and electrically contact first electrodes 510A, but do not come into contact with second electrodes 510B. While not shown, a similar second bus bar with protrusions can be used to contact the second electrodes 510B. Similar to FIG. 8, the first and second electrodes 510A, 510B can extend in a first direction and the first bus bar 511B and second bus bar can extend in a second direction that is transverse to the first direction. The first and second bus bars can be on the same side of the substrate (e.g., similar to FIG. 6B) or on opposing sides of the substrate (e.g., similar to FIG. 6A). In some embodiments, the first and/or second bus bars can be applied to a major surface of the substrate, e.g., proximate to one or more edges of the substrate. Alternatively, the first and/or second bus bars can be wrapped around one or more edges of the substrate.

According to various embodiments, the methods disclosed herein can comprise patterning the first bus bar with a plurality of first protrusions. The distance between the first protrusions can be substantially equal to a distance between the first electrodes on the first major surface of the patterned substrate. The methods can still further comprise patterning the second bus bar with a plurality of second protrusions. The distance between the second protrusions can be substantially equal to a distance between the second electrodes on the first major surface of the patterned substrate.

Referring to FIGS. 10A-B, a double bus bar 611 can be used in certain embodiments. FIG. 10A illustrates a top view of such a double bus bar 611, which comprises first and second electrically conductive regions 613A, 613B separated by an insulating region 614. While not depicted, it is also possible for double bus bar 611 to be split into two or more sections, each section of which can be controlled separately. Using such a configuration, it can be possible to provide liquid crystal windows with the appearance of horizontal or vertical blinds.

As shown in FIG. 10B, the underside of double bus bar 611 comprises first and second patterned conductors 615A, 615B that correspond with the spacing and geometry of the alternating electrodes of the motherboard sheet (not illustrated). For instance, the patterned conductors 615A, 615B can comprise raised protrusions on a first major surface of the double bus bar 611. First patterned conductors 615A can electrically contact alternating electrodes, e.g., first (positive) electrodes, and second patterned conductors 615B can contact alternating electrodes, e.g., second (negative) electrodes. In such an embodiment, all electrodes can be connected to the double bus bar 611 via first and second patterned conductors 615A, 615B, but the insulating region 614 ensures electrical contact between only first conductive region 613A and first patterned conductors 615A, and between only second conductive region 613B and second patterned conductors 615B. As such, first conductive region 613A is in electrical contact with first electrodes (not illustrated) via first patterned conductors 615A, and second conductive region 613B is in electrical contact with second electrodes (not illustrated) via second patterned conductors 615B. One double bus bar 611 can be positioned proximate to one edge of the substrate or two double bus bars can be positioned proximate opposing edges of the substrate (e.g., similar to FIG. 6A). In the latter case, it is possible to connect both conductive regions of both double bus bars to driving circuitry to decrease resistance. Alternatively, it is possible to connect only one conductive region of each double bus bar to the appropriate driving circuitry.

According to various embodiments, the methods for making interdigitated electrode assemblies comprise depositing a plurality of first electrodes and a plurality of second electrodes on a first major surface of a template sheet, wherein the plurality of first electrodes and the plurality of second electrodes are interdigitated; singulating the template sheet to produce at least one patterned substrate comprising the plurality of first electrodes and the plurality of second electrodes extending on a first major surface of the patterned substrate along a first direction from a first edge to a second edge of the patterned substrate; and positioning a bus bar on the first major surface proximate the first edge of the patterned substrate along a second direction transverse to the first direction. According to additional embodiments, the bus bar comprises a first conductive region and a second conductive region separated by an insulating region and the bus bar overlays the plurality of first electrodes and the plurality of second electrodes. In non-limiting embodiments, the first conductive region of the bus bar does not electrically contact the plurality of second electrodes and the second conductive region of the bus bar does not electrically contact the plurality of first electrodes. According to certain embodiments, the methods further comprise patterning a first major surface of the bus bar with a plurality of first patterned conductors and a plurality of second patterned conductors. The first patterned conductors can be spaced apart by a first distance substantially equal to a distance between the first electrodes and electrically contact the plurality of first electrodes. The second patterned conductors can be spaced apart by a second distance substantially equal to a distance between the second electrodes and electrically contact the plurality of second electrodes.

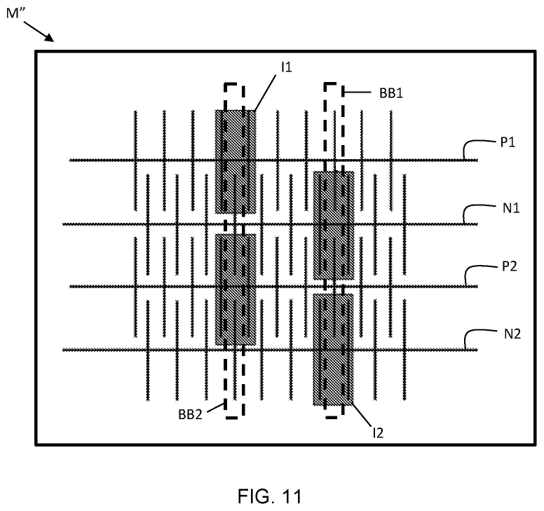

FIG. 11 depicts yet another embodiment of the disclosure, in which a template or motherboard sheet M″ is patterned with alternating positive (first) P1, P2 and negative (second) N1, N2 electrodes. First insulators 11 are discontinuously deposited in strips or columns to cover or overlay at least a portion of alternate electrodes, e.g., positive electrodes P1, P2. Second insulators 12 are discontinuously deposited in adjacent strips or columns to at least partially cover or overlay at least a portion of the other alternate electrodes, e.g., negative electrodes N1, N2. While only one strip of first insulators 11 and one strip of second insulators 12 is illustrated, it is to be understood that more than one of each insulating strip can be applied across the length or width of the motherboard sheet. A first bus bar BB1 can be deposited or attached to the desired strip of insulators, e.g., second insulators 12, such that electrical contact is permitted between first bus bar BB1 and positive electrodes P1, P2, but prevented between first bus bar BB1 and negative electrodes N1, N2. Likewise, a second bus bar BB2 can be deposited or attached to the desired strip of insulators, e.g., first insulators 11, such that electrical contact is permitted between second bus bar BB2 and negative electrodes N1, N2, but prevented between second bus bar BB2 and positive electrodes P1, P2. Such a method allows for bulk patterning of the motherboard sheet followed by singulation and attachment of the bus bars in the appropriate positions to electrically contact the desired set of electrodes, regardless of the geometry of the template sheet or cut-to-order substrate.

According to various embodiments, the methods disclosed herein can comprise positioning at least one first insulator on the first major surface of a template sheet along the second direction prior to singulation. The at least one first insulator can overlay at least a portion of the plurality of second electrodes and the first bus bar can overlay the at least one first insulator when applied to the first major surface of the patterned substrate after singulation. The methods can further comprise positioning at least one second insulator on the first major surface of the template sheet along the second direction prior to singulation. The at least one second insulator can overlay at least a portion of the plurality of first electrodes and a second bus bar can overlay the at least one second insulator on the first major surface of the patterned substrate after singulation. This method may be advantageous in term of minimizing the number of steps carried out after singulation, e.g., the patterning of insulating material occurs pre-singulation and then the singulated part need only be aligned with the machinery or device that applies the conductive bus bar material.

Methods for assembling liquid crystal devices and liquid crystal windows are also disclosed herein. Such methods can comprise including at least one interdigitated electrode assembly disclosed herein as one or more substrates in the devices or windows, for example, one or more of the outer substrates and/or interstitial substrate(s) of the liquid crystal device or window can comprise an interdigitated electrode assembly as described herein.

### Materials

### Substrates

The assemblies and devices disclosed herein can comprise at least one substrate or sheet, such as substrates 101, 102, 201, 202, 207, 300, 300′, 400, and 500, or sheets M, M′, M″. According to non-limiting embodiments, the substrate(s) or sheet(s) may comprise an optically transparent material. As used herein, the term “optically transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 95%, including all ranges and subranges therebetween. In certain embodiments, all of the substrates in the disclosed assemblies or devices comprise an optically transparent material.

In non-limiting embodiments, the substrate(s) or sheet(s) may comprise optically transparent glass sheets. According to other embodiments, the substrate(s) or sheet(s) may comprise a material other than glass, such as plastics and ceramics, including glass ceramics. Suitable plastic materials include, but are not limited to, polycarbonates, polyacrylates such as polymethylmethacrylate (PMMA), and polyethyelenes such as polyethylene terephthalate (PET). The substrate(s) or sheet(s) can have any shape and/or size, such as a rectangle, square, or any other suitable shape, including regular and irregular shapes and shapes with one or more curvilinear edges. According to various embodiments, the substrate(s) or sheet(s) can have a thickness of less than or equal to about 4 mm, for example, ranging from about 0.005 mm to about 4 mm, from about 0.01 mm to about 3 mm, from about 0.02 mm to about 2 mm, from about 0.05 mm to about 1.5 mm, from about 0.1 mm to about 1 mm, from about 0.2 mm to about 0.7 mm, or from about 0.3 mm to about 0.5 mm, including all ranges and subranges therebetween. In certain embodiments, the substrate(s) or sheet(s) can have a thickness of less than or equal to 0.5 mm, such as 0.4 mm, 0.3 mm, 0.2 mm, 0.1 mm, 0.05 mm, 0.02 mm, 0.01 mm, or 0.005 mm, including all ranges and subranges therebetween. In non-limiting embodiments, the substrate(s) or sheet(s) can have a thickness ranging from about 1 mm to about 3 mm, such as from about 1.5 to about 2 mm, including all ranges and subranges therebetween.

The substrate(s) or sheet(s) may comprise any glass known in the art, for example, soda-lime silicate, aluminosilicate, alkali-aluminosilicate, borosilicate, alkaliborosilicate, aluminoborosilicate, alkali-aluminoborosilicate, and other suitable display glasses. The substrate(s) or sheet(s) may, in some embodiments, be chemically strengthened and/or thermally tempered. Non-limiting examples of suitable commercially available glasses include EAGLE XG®, LotusTM, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

According to various embodiments, the substrate(s) or sheet(s) may be chosen from glass sheets produced by a fusion draw process. Without wishing to be bound by theory, it is believed that the fusion draw process can provide glass sheets with a relatively low degree of waviness (or high degree of flatness), which may be beneficial for various liquid crystal applications. An exemplary glass substrate may thus, in certain embodiments, comprise a surface waviness of less than about 100 nm as measured with a contact profilometer, such as about 80 nm or less, about 50 nm or less, about 40 nm or less, or about 30 nm or less, including all ranges and subranges therebetween. An exemplary standard technique for measuring waviness (0.8˜8 mm) with a contact profilometer is outlined in SEMI D15-1296 “FPD Glass Substrate Surface Waviness Measurement Method.” According to further embodiments, the substrate(s) or sheet(s) may comprise a highly conductive transparent material, for instance, a material having an electrical conductivity of at least about 10⁵ S/m, at least about 10⁴ S/m, at least about 10³ S/m, at least about 10² S/m, at least about 0.1 S/m, at least about 1 S/m, at least about 10 S/m, or at least about 100 S/m, e.g., ranging from 0.0001 S/m to about 1000 S/m, including all ranges and subranges therebetween.

### Electrodes and Bus Bars

The assemblies and devices disclosed herein can comprise at least one interdigitated electrode and one or more bus bars connecting the interdigitated electrodes. Interdigitated electrodes and bus bars can comprise the same or different conductive materials. Suitable conductive materials can comprise one or more transparent conductive oxides (TCOs), such as indium tin oxide (ITO), indium zinc oxide (IZO), gallium zinc oxide (GZO), aluminum zinc oxide (AZO), and other like materials. Alternatively, other transparent materials, such as a conductive mesh, e.g., comprising metals such as silver nanowires or other nanomaterials such as graphene or carbon nanotubes can be used. Printable conductive ink layers such as ActiveGrid™M from C3Nano Inc. may also be used. Combinations of materials can also be used. For instance, a patterned bus bar may comprise two or more conductive materials, such as a metal strip patterned with a second conductive material such as an ink or conductive oxide. Certain bus bars, such as the double bus bar, may also comprise insulating materials (see, e.g., FIGS. 10A-B), which are discussed in more detail below.

The interdigitated electrodes and bus bars can, in some

embodiments, be deposited on at least one major surface of at least one substrate in a liquid crystal device, e.g., an interior surface of one or more of the outer (e.g., first and second) substrates, or on at least one opposing surface of the interstitial (e.g., third) substrates, if present. The thickness of each interdigitated electrode or bus bar can, for example, independently range from about 1 nm to about 1000 nm such as from about 5 nm to about 500 nm, from about 10 nm to about 300 nm, from about 20 nm to about 200 nm, from about 30 nm to about 150 nm, or from about 50 nm to about 100 nm, including all ranges and subranges therebetween. According to various embodiments, the sheet resistance (e.g., as measured in ohms-per-square) of the interdigitated electrodes and/or bus bars can range from about 10 Ω/□ (ohms/square) to about 1000 Ω/□, such as from about 50 Ω/□ to about 900 Ω/□, from about 100 Ω/□ to about 800 Ω/ϵ, from about 200 Ω/□ to about 700 Ω/□, from about 300 Ω/□ to about 600 Ω/□, or from about 400 Ω/□ to about 500 Ω/□, including all ranges and subranges therebetween. The individual electrodes and bus bars present in the disclosed assemblies and devices may comprise the same or different materials, the same or different thicknesses, and the same or different patterns.

### Insulating Materials

The assemblies and devices disclosed herein can, in certain embodiments, comprise at least one insulator. The insulator(s) can comprise any electrically insulative organic or inorganic material, such as SiN, SiO₂, or insulating polymers. The insulator(s) can be applied as a continuous or discontinuous layer. An exemplary thickness for the insulating layer can range from about 10 nm to about 1000 nm such as from about 20 nm to about 500 nm, from about 25 nm to about 400 nm, from about 30 nm to about 300 nm, from about 40 nm to about 200 nm, or from about 50 nm to about 100 nm, including all ranges and subranges therebetween.

### Alignment Layers

In some embodiments, the liquid crystal devices and windows disclosed herein can comprise one or more alignment layers. The individual alignment layers present in the liquid crystal devices may, in some embodiments, comprise the same or different materials, the same or different thicknesses, and the same or different orientations relative to one another. Alignment layers can comprise a thin film of material having a surface energy and anisotropy promoting the desired orientation for the liquid crystals in direct contact with its surface. Exemplary materials include, but are not limited to, main chain or side chain polyimides, which can be mechanically rubbed to generate layer anisotropy; photosensitive polymers, such as azobenzene-based compounds, which can be exposed to linearly polarized light to generate surface anisotropy; and inorganic thin films, such as silica, which can be deposited using thermal evaporating techniques to form periodic microstructures on the surface.

According to various embodiments, the alignment layers can have a thickness of less than or equal to about 100 nm, for example, ranging from about 1 nm to about 100 nm, from about 5 nm to about 90 nm, from about 10 nm to about 80 nm, from about 20 nm to about 70 nm, from about 30 nm to about 60 nm, or from about 40 nm to about 50 nm, including all ranges and subranges therebetween.

### Liquid Crystal Layers

In additional embodiments, the liquid crystal devices and windows disclosed herein can comprise at least one liquid crystal layer disposed between at least two substrates, for example, one liquid crystal layer defined by two substrates, or two liquid crystal layers defined three substrates. The individual liquid crystal layers in the device may comprise the same or different liquid crystal materials and/or additives, the same or different thicknesses, the same or different switching modes, and the same or different orientations relative to one another.

A liquid crystal layer can comprise liquid crystals and one or more additional components, such as dyes or other coloring agents, chiral dopants, polymerizable reactive monomers, photoinitiators, polymerized structures, or any combination thereof. The liquid crystals can have any liquid crystal phase, such as achiral nematic liquid crystal (NLC), chiral nematic liquid crystal, cholesteric liquid crystal (CLC), or smectic liquid crystal, which are operable over a broad range of temperatures, such as from about −40° C. to about 110° C.

According to various embodiments, the liquid crystal layers can comprise a cell gap or cavity that is filled with liquid crystal material. The thickness of the liquid crystal layer, or the cell gap distance, can be maintained by particle spacers and/or columnar spacers dispersed in the liquid crystal layer. The liquid crystal layers can have a thickness of less than or equal to about 0.2 mm, for example, ranging from about 0.001 mm to about 0.1 mm, from about 0.002 mm to about 0.05 mm, from about 0.003 mm to about 0.04 mm, from about 0.004 mm to about 0.03 mm, from about 0.005 mm to about 0.02 mm, or from about 0.01 mm to about 0.015 mm, including all ranges and subranges therebetween. The individual liquid crystal layers in the device may all comprise the same thickness, or may have different thicknesses.

The substrates in the liquid crystal device can have a surface energy promoting the desired alignment of the liquid crystal director in a ground or “off” state without applied voltage. A vertical or homeotropic alignment is achieved when the liquid crystal director has a perpendicular or substantially perpendicular orientation with respect to the plane of the substrate. A planar or homogeneous alignment is achieved when the liquid crystal director has a parallel or substantially parallel orientation with respect to the plane of the substrate. An oblique alignment is achieved when the liquid crystal direction has a large angle with respect to the plane of the substrate, which is substantially different from planar or homeotropic, i.e., ranging from about 20° to about 70°, such as from about 30° to about 60°, or from about 40° to about 50°, including all ranges and subranges therebetween.

In some embodiments, dyes or other coloring agents, such as dichroic dyes, can be added to one or more of the liquid crystal layers to absorb light transmitted through the liquid crystal layer(s). Dichroic dyes typically absorb light more strongly along a direction parallel to the direction of a transition dipole moment in the dye molecule, which is typically the longer molecular axis of the dye molecule. Dye molecules oriented with their long axis perpendicular to the direction of light polarization will provide low light attenuation, whereas dye molecules oriented with their long axis parallel to the direction of light polarization will provide strong light attenuation.

One or more chiral dopants may be added to the liquid crystal mixture to form highly twisted cholesteric liquid crystals (CLC), which may have a random alignment that provides light scattering effects, referred to herein as a focal conic texture. Random liquid crystal alignment can also be promoted or assisted by including polymer structures, such as polymer fibers, in the matrix of the liquid crystal layer, referred to herein as polymer stabilized cholesteric texture (PSCT). Random liquid crystal alignment can also be achieved using small droplets of nematic liquid crystal (without a chiral dopant) randomly dispersed in a solid polymer layer or a dense network of polymer fibers, or polymer walls, referred to herein as polymer dispersed liquid crystal (PDLC).

According to various embodiments, polymers may be dispersed in the matrix of the liquid crystal layer or on the interior surfaces of the glass and interstitial substrates. Such polymers may be formed by polymerization of monomers dissolved in the liquid crystal mixture. In certain embodiments, polymer protrusions or other polymerized structures may be formed on the interior surfaces of the outer substrates and/or interstitial substrates, such as in a normally clear liquid crystal device with homeotropic alignment layer(s), to define an azimuthal switching direction and to improve electro-optic switching speed.

As noted above, chiral dopants may be added to the liquid crystal mixture to achieve a twisted supramolecular structure of liquid crystal molecules, referred to herein as cholesteric liquid crystal (CLC). The amount of twist in the CLC is described by a helical pitch which represents the rotation angle of a local liquid crystal director by 360 degrees across the cell gap thickness. CLC twist can also be quantified by a ratio (d/p) of cell gap thickness (d) to CLC helical pitch (p). For liquid crystal applications, the amount of chiral dopant dissolved in the liquid crystal mixture can be controlled to achieve a desired amount of twist across a given cell gap distance. It is within the ability of one skilled in the art to select the appropriate dopant and its amount to achieve the desired twisted effect.

In various embodiments, the liquid crystal layers disclosed herein may have an amount of twist ranging from about 0° to about 25×360° (or d/p ranging from about 0 to about 25.0), for example, ranging from about 45° to about 1080° (d/p from about 0.125 to about 3), from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. As used herein, a liquid crystal mixture that does not include chiral dopants is referred to as a nematic liquid crystal (NLC). A liquid crystal that includes a chiral dopant and has a small pitch and a large twist refers to a CLC mixture wherein d/p is greater than 1. A liquid crystal that includes a chiral dopant and has a large pitch and a small twist refers to a CLC mixture wherein d/p is less than or equal to 1.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device or method that comprises A+B+C include embodiments where a device or method consists of A+B+C and embodiments where a device or method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. An interdigitated electrode assembly comprising:
(a) a substrate comprising a first major surface, an opposing second major surface, a first edge, and an opposing second edge;
(b) a plurality of first electrodes and a plurality of second electrodes positioned on the first major surface of the substrate and extending in a first direction from the first edge to the second edge of the substrate, wherein the plurality of first electrodes and the plurality of second electrodes are interdigitated;
(c) at least one first insulator positioned on the first major surface proximate the first edge of the substrate, wherein the at least one first insulator overlays at least a portion of the plurality of second electrodes; and
(d) a first bus bar positioned on the first major surface proximate the first edge of the substrate, wherein the first bus bar overlays the at least one first insulator and does not electrically contact the plurality of second electrodes.

2. The interdigitated electrode assembly of claim 1, further comprising:
(e) at least one second insulator, wherein the at least one second insulator overlays at least a portion of the plurality of first electrodes; and
(f) a second bus bar, wherein the second bus bar overlays the at least one second insulator and does not electrically contact the plurality of first electrodes.

3. The interdigitated electrode assembly of claim 2, wherein the at least one second insulator and the second bus bar are positioned on the first major surface proximate the second edge of the substrate.

4. The interdigitated electrode assembly of claim 2 or 3, wherein the at least one second insulator and the second bus bar are positioned on the first major surface adjacent the at least one first insulator and the first bus bar.

5. The interdigitated electrode assembly of claim 1, wherein the at least one first insulator comprises a discontinuous layer of insulating material extending in a second direction transverse to the first direction, and wherein the at least one first insulator does not contact the plurality of first electrodes.

6. The interdigitated electrode assembly of claim 5, wherein the at least one second insulator comprises a discontinuous layer of insulating material extending in the second direction, and wherein the at least one second insulator does not contact the plurality of second electrodes.

7. The interdigitated electrode assembly of claim 1, wherein the at least one first insulator comprises a continuous layer of insulating material overlaying both the plurality of first electrodes and the plurality of second electrodes, and wherein first bus bar extends in a second direction transverse to the first direction and comprises a plurality of first protrusions extending through the at least one first insulator to electrically contact the plurality of first electrodes.

8. The interdigitated electrode assembly of claim 7, wherein a distance between the first protrusions on the first bus bar is substantially equal to a distance between first electrodes on the first major surface of the substrate.

9. The interdigitated electrode assembly of claim 7 or 8, further comprising a second bus bar extending in a second direction transverse to the first direction and comprising a plurality of second protrusions extending through the at least one first insulator to electrically contact the plurality of second electrodes.

10. The interdigitated electrode assembly of claim 9, wherein a distance between the second protrusions on the second bus bar is substantially equal to a distance between second electrodes on the first major surface of the substrate.

11. An interdigitated electrode assembly comprising:
(a) a substrate comprising a first major surface, an opposing second major surface, a first edge, and an opposing second edge;
(b) a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and
(c) a first bus bar positioned on the first major surface proximate the first edge of the substrate and extending in a second direction transverse to the first direction,
wherein the first bus bar is patterned with a plurality of first protrusions spaced apart by a distance substantially equal to a distance between first electrodes, and
wherein the first bus bar electrically contacts the plurality of first electrodes but does not electrically contact the plurality of second electrodes.

12. The interdigitated electrode assembly of claim 11, further comprising a second bus bar patterned with a plurality of second protrusions spaced apart by a distance substantially equal to a distance between second electrodes, wherein the second bus bar electrically contacts the plurality of second electrodes but does not electrically contact the plurality of first electrodes.

13. The interdigitated electrode assembly of claim 12, wherein the second bus bar is positioned on the first major surface proximate the second edge of the substrate.

14. The interdigitated electrode assembly of claim 12 or 13, wherein the second bus bar is positioned on the first major surface adjacent the first bus bar.

15. An interdigitated electrode assembly comprising:
(a) a substrate comprising a first major surface, an opposing second major surface, a first edge, and an opposing second edge;
(b) a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and
(c) a bus bar positioned on the first major surface proximate the first edge of the substrate and extending in a second direction transverse to the first direction, wherein the bus bar comprises a first conductive region and a second conductive region separated by an insulating region,
wherein a first major surface of the bus bar is patterned with a plurality of first protrusions and a plurality of second protrusions,
wherein the first protrusions are spaced apart by a first distance substantially equal to a distance between the first electrodes and electrically contact the plurality of first electrodes,
wherein the second protrusions are spaced apart by a second distance substantially equal to a distance between the second electrodes and electrically contact the plurality of second electrodes,
wherein the first conductive region of the bus bar does not electrically contact the plurality of second electrodes and the second conductive region of the bus bar does not electrically contact the plurality of first electrodes.

16. An interdigitated electrode assembly comprising:
(a) a substrate comprising a first major surface, an opposing second major surface, a first edge, and an opposing second edge;
(b) a plurality of first electrodes and a plurality of second electrodes positioned on the first major surface of the substrate and extending in a first direction from the first edge to the second edge of the substrate, wherein the plurality of first electrodes and the plurality of second electrodes are interdigitated; and
(c) a first bus bar positioned on the first major surface proximate the first edge of the substrate and extending in a second direction transverse to the first direction,
wherein the first major surface of the substrate comprises a surface texture and wherein the surface texture prevents physical and electrical contact between the first bus bar and the plurality of second electrodes.

17. The interdigitated electrode assembly of claim 16, wherein the surface texture comprises peaks and troughs, wherein along a first transverse plane proximate the first edge of the substrate the plurality of second electrodes is disposed in the troughs and the plurality of first electrodes is disposed on the peaks, and wherein the first bus bar is disposed along the first transverse plane proximate the first edge of the substrate.

18. The interdigitated electrode assembly of claim 16 or 17, further comprising a second bus bar positioned on the first major surface proximate the second edge of the substrate, wherein the surface texture prevents physical contact between the second bus bar and the first plurality of electrodes.

19. The interdigitated electrode assembly of claim 18, wherein the surface texture comprises peaks and troughs, wherein along a second transverse plane proximate the second edge of the substrate the plurality of first electrodes is disposed in the troughs and the plurality of second electrodes is disposed on the peaks, and wherein the second bus bar is disposed along the second transverse plane proximate the second edge of the substrate.

20. A liquid crystal device or liquid crystal window comprising the interdigitated electrode assembly of any of claims 1-19.

21. The liquid crystal device or liquid crystal window of claim 20, further comprising a first outer substrate, a second outer substrate, an interstitial substrate, a first liquid crystal layer disposed between the first outer substrate and the interstitial substrate, and a second liquid crystal layer disposed between the second outer substrate and the interstitial substrate, and
wherein at least one of the first outer substrate, second outer substrate, and interstitial substrate comprises the interdigitated electrode assembly.

22. A method for making an interdigitated electrode assembly, the method comprising:
(a) depositing a plurality of first electrodes and a plurality of second electrodes on a first major surface of a template sheet, wherein the plurality of first electrodes and the plurality of second electrodes are interdigitated;
(b) singulating the template sheet to produce at least one patterned substrate comprising the plurality of first electrodes and the plurality of second electrodes extending on a first major surface of the patterned substrate along a first direction from a first edge to a second edge of the patterned substrate;
(c) positioning a first bus bar on the first major surface proximate the first edge of the patterned substrate along a second direction transverse to the first direction, wherein the first bus bar overlays the plurality of first electrodes and the plurality of second electrodes and does not electrically contact the plurality of second electrodes.

23. The method of claim 22, further comprising positioning a second bus bar on the first major surface of the patterned substrate along the second direction, wherein the second bus bar overlays the plurality of first electrodes and the plurality of second electrodes and does not electrically contact the plurality of first electrodes.

24. The method of claim 22 or 23, further comprising positioning at least one first insulator on the first major surface proximate the first edge of the patterned substrate along the second direction, wherein the first bus bar overlays the at least one first insulator.

25. The method of claim 24, wherein positioning the at least one first insulator comprises applying a discontinuous layer of insulating material along the second direction, wherein the at least one first insulator does not contact the plurality of first electrodes.

26. The method of claim 24 or 25, further comprising positioning at least one second insulator on the first major surface along the second direction, wherein the second bus bar overlays the at least one second insulator.

27. The method of claim 26, wherein positioning the at least one second insulator comprises applying a discontinuous layer of insulating material along the second direction, wherein the at least one second insulator does not contact the plurality of second electrodes.

28. The method of claim 24, wherein positioning the at least one first insulator comprises applying a continuous layer of insulating material overlaying both the plurality of first electrodes and the plurality of second electrodes, and wherein the first bus bar comprises a plurality of first protrusions extending through the at least one first insulator to electrically contact the plurality of first electrodes.

29. The method of claim 28, further comprising patterning the first bus bar with the plurality of first protrusions, wherein a distance between the first protrusions is substantially equal to a distance between the first electrodes on the first major surface of the patterned substrate.

30. The method of claim 28 or 29, further comprising positioning a second bus bar on the first major surface of the patterned substrate along the second direction, wherein the second bus bar overlays the plurality of first electrodes and the plurality of second electrodes, and wherein the second bus bar comprises a plurality of second protrusions extending through the at least one first insulator to electrically contact the plurality of second electrodes.

31. The method of claim 30, further comprising patterning the second bus bar with the plurality of second protrusions, wherein a distance between the second protrusions is substantially equal to a distance between the second electrodes on the first major surface of the patterned substrate.

32. The method of claim 22, further comprising positioning at least one first insulator on the first major surface of the template sheet along the second direction prior to singulation, wherein the at least one first insulator overlays at least a portion of the plurality of second electrodes, and wherein the first bus bar overlays the at least one first insulator when applied to the first major surface of the patterned substrate after singulation.

33. The method of claim 32, further comprising positioning at least one second insulator on the first major surface of the template sheet along the second direction prior to singulation, wherein the at least one second insulator overlays at least a portion of the plurality of first electrodes, and positioning a second bus bar to overlay the at least one second insulator on the first major surface of the patterned substrate after singulation.

34. The method of claim 22, further comprising patterning the first bus bar with a plurality of first protrusions, wherein a distance between the first protrusions is substantially equal to a distance between the first electrodes on the first major surface of the patterned substrate.

35. The method of claim 34, further comprising patterning the second bus bar with a plurality of second protrusions, wherein a distance between the second protrusions is substantially equal to a distance between the second electrodes on the first major surface of the patterned substrate.

36. The method of claim 22, further comprising patterning the first bus bar with a plurality of first insulators, wherein a distance between the first insulators is substantially equal to a distance between the second electrodes on the first major surface of the patterned substrate.

37. The method of claim 36, further comprising patterning the second bus bar with a plurality of second insulators, wherein a distance between the second insulators is substantially equal to a distance between the first electrodes on the first major surface of the patterned substrate.

38. The method of claim 22, further comprising texturing the first major surface of the template sheet to provide a surface texture prior to depositing the plurality of first electrodes and the plurality of second electrodes, wherein the plurality of first and second electrodes are deposited at an angle ranging from 0° to 90° relative to at least one feature of the surface texture.

39. The method of claim 38, wherein texturing the first major surface of the template sheet comprises providing the surface with a plurality of peaks and troughs.

40. The method of claim 38 or 39, further comprising selecting a first position of the first bus bar proximate the first edge of the patterned substrate, wherein at the selected first position a first elevation of the plurality of first electrodes from the surface of the patterned substrate is greater than a second elevation of the plurality of second electrodes.

41. The method of any of claims 38-40, further comprising positioning a second bus bar on the first major surface along the second direction and selecting a second position of the second bus bar, wherein at the selected second position the second elevation of the plurality of second electrodes is greater than the first elevation of the plurality of first electrodes.

42. A method for making an interdigitated electrode assembly, the method comprising:
(a) depositing a plurality of first electrodes and a plurality of second electrodes on a first major surface of a template sheet, wherein the plurality of first electrodes and the plurality of second electrodes are interdigitated;
(b) singulating the template sheet to produce at least one patterned substrate comprising the plurality of first electrodes and the plurality of second electrodes extending on a first major surface of the patterned substrate along a first direction from a first edge to a second edge of the patterned substrate;
(c) positioning a bus bar on the first major surface proximate the first edge of the patterned substrate along a second direction transverse to the first direction, wherein the bus bar comprises a first conductive region and a second conductive region separated by an insulating region,
wherein the bus bar overlays the plurality of first electrodes and the plurality of second electrodes, and
wherein the first conductive region of the bus bar does not electrically contact the plurality of second electrodes and the second conductive region of the bus bar does not electrically contact the plurality of first electrodes.

43. The method of claim 42, further comprising patterning a first major surface of the bus bar with a plurality of first patterned conductors and a plurality of second patterned conductors,
wherein the first patterned conductors are spaced apart by a first distance substantially equal to a distance between the first electrodes and electrically contact the plurality of first electrodes, and
wherein the second patterned conductors are spaced apart by a second distance substantially equal to a distance between the second electrodes and electrically contact the plurality of second electrodes.

44. The method of any of claims 22-43, further comprising assembling a liquid crystal device or liquid crystal window comprising at least one interdigitated electrode assembly.
